(19) United States
(12) Patent Application Publication
(10) Pub. No.: US 2003/0014768 A1
(43) Pub. Date: Jan. 16, 2003

(54) Recording apparatus

(76) Inventors: Kazuhide Ishihara, Osaka (JP); Toshihiro Takagi, Osaka (JP)

Correspondence Address: Jonathan P. Osha, ROSENTHAL & OSHA L.L.P., 700 Louisiana, Suite 4550, Houston, TX, 77002, US

(21) Appl. No.: 10/194,143

(22) Filed: Jul. 12, 2002

(30) Foreign Application Priority Data
Jul. 16, 2001 (JP) P.2001-214700

(51) Int. Cl. H04N 7/173; H04N 7/16

(52) U.S. Cl. 725/133; 725/141; 725/153

(57) ABSTRACT

In a recording apparatus for enabling the user to keep calm in viewing a recorded program, when change is made in PID information for the recorded program, a recording apparatus stores an index indicating that change is made in PID information. The program is played back based on the stored index. Since the program and a CM differ in PID information, the index can be used easily to skip the CM at the playback time, the operability of the user is enhanced, and the user can keep calm in viewing the played program.

### BACKGROUND OF THE INVENTION

1. Field of the Invention

This invention relates to a recording apparatus for receiving a program distributed in a digital broadcast and recording the received program.

2. Description of the Related Art

Hitherto, digital broadcasts of ATSC (Advanced Television Standards Committee) system, etc., have been started. In the digital broadcasts, a plurality of programs are broadcasted on one physical channel. Specifically, a plurality of virtual channels can be formed on one physical channel and a program can be broadcasted for each virtual channel. Thus, in the digital broadcasts, for each program broadcasted on the physical channel, PID (Program Identification) information, etc., of video and audio making up the program is distributed as channel information together with data of the program.

In an apparatus for receiving digital broadcasts (simply, reception apparatus), the channel to be received is specified as the virtual channel.

A general reception apparatus comprises a reception section, a front end, and a back end. The reception section is a tuner for extracting a signal of the physical channel on which the specified virtual channel is formed. The front end acquires channel information from the physical channel signal extracted in the reception section and obtains PID information of video and audio making up the program broadcasted on the specified virtual channel. The front end also outputs a bit stream extracting the data of the video and audio making up the program broadcasted on the specified virtual channel from the physical channel signal based on the obtained PID information. The back end converts the bit stream output by the front end into a video signal and an audio signal for output. The video signal and the audio signal output from the back end are converted into signals in the format responsive to the output unit connected to the reception apparatus, for example, analog signal of the NTSC system for output.

By the way, a recording apparatus comprising a storage medium such as a hard disk or a DVD on which the bit stream output by the front end is stored for recording a program distributed in a digital broadcast is available.

However, a commercial message (CM) is also inserted in a program such as a movie in the digital broadcast like a conventional analog broadcast. Thus, if a broadcasted program is recorded, the CM inserted in the recorded program is also recorded.

To play back the recorded program, many users skip CMs. Specifically, when the playback position changes from the program to a CM, the user performs fast-forward operation and when the playback position reaches a position where change is made from the CM to the program, the user stops the fast-forward operation and restarts playback. While seeing the screen, the user himself or herself determines whether or not the playback position reaches the position where change is made from the CM to the program.

If the user stops the fast-forward operation too early or too late and the playback restart position is not the position where change is made from the CM to the program, the user must again perform the fast-forward operation or perform rewind operation. Thus, the operation of skipping CMs in the playback mode is intricate and the ease of use is poor and the user cannot keep calm in viewing the played program; this is a problem.

Arts of discriminating between a program and a CM from received broadcast are disclosed in JP-A-11-168759, JP-A-4-8544U, etc.

### SUMMARY OF THE INVENTION

It is an object of the invention to provide a recording apparatus whose operability is enhanced for enabling the user to keep calm in viewing a recorded program.

To solve the above-described problem, the recording apparatus of the invention comprises the following configuration:

(1) Reception means for receiving a digital broadcast signal of a specified channel;

recording means for recording a program broadcasted on the specified channel;

channel information extraction means for extracting channel information of the program recorded by the recording means from the digital broadcast signal received by the reception means;

channel information change detection means for detecting change in the channel information extracted by the channel information extraction means;

index means, when the channel information change detection means detects change in the channel information, for adding an index indicating change in the channel information to the program recorded by the recording means;

playback means for playing back the program recorded by the recording means; and

edit means for editing the program based on the index added to the program recorded by the recording means.

In the configuration, the channel information extraction means extracts the channel information of the recorded program. The channel information mentioned here refers to PID (Program Identification) information of data forming video and audio of program and CM broadcasted on the record channel, for example. Usually, program and CM even on the same channel differ in PID information. For example, if a CM of a monolingual broadcast is inserted in a program of a bilingual broadcast, the program and the CM differ in PID number of audio. The program and the CM may differ in PID number of video or audio.

Therefore, when change is made in the PID information for the recorded program, the broadcast changes from the program to CM or CM to the program.

When the channel information change detection means detects change in the PID information, an index is added to the recorded program. This index contains the record position, etc., at the PID information change timing.

When the recorded program is played back, the index can be used to skip the CM without making the user perform intricate operation.

(2) The recording apparatus further comprises playback means for playing back the program recorded by the recording means, the playback means being means for storing the channel information of the played program when a predetermined entry is made when the program is played back, and skipping record data having channel information different from the stored channel information based on the index added by the index means.

In the configuration, when playing back the recorded program, the user performs predetermined entry operation for storing the PID information of the program. The playback means plays back the program while skipping record data having PID information different from the PID information of the program, namely, CM record data. Therefore, if the user performs the predetermined entry operation only once when playing back the program, later the program is played back automatically while CMs are skipped, so that the user can keep calm in viewing the program.

(3) The recording apparatus further comprises playback means for playing back the program recorded by the recording means, the playback means being means for storing the channel information of the played program when a predetermined entry is made when the program is played back, and skipping record data having channel information different from the stored channel information based on the index added by the index means.

In the configuration, when the program is recorded, the user performs predetermined entry operation for storing the PID information of the program. If PID information differs from the PID information of the program, the recording means stops recording. Therefore, only the program can be recorded (with CMs cut), and the storage capacity of a storage medium such as a hard disk or a DVD for recording programs can be used efficiently.

(4) The recording means is means for temporarily stopping the recording operation until change is made in the channel information of the recorded program when a predetermined entry is made at the program recording time.

In the configuration, when a CM is recorded, the user performs predetermined entry operation, whereby the recording operation is temporarily stopped. The temporarily stopped recording operation is restarted when change is made in PID information.

Therefore, the storage capacity for recording CMs can be suppressed and a storage medium such as a hard disk or a DVD for recording programs can be used efficiently.

(5) The recording means has means for deleting the already recorded portion of the program having the same channel information as the recorded program when the predetermined entry is made.

In the configuration, the record data involving the already recorded CM before the user performs the predetermined operation is also deleted. Therefore, the storage capacity for recording CMs can be still more suppressed, and a storage medium such as a hard disk or a DVD for recording programs can be used still more efficiently.

(6) The recording apparatus further comprises edit means for editing the program based on the index added to the program recorded by the recording means.

In the configuration, the program recorded based on the index can be edited, so that the CM part can be easily recognized from the record data and the editing is facilitated.

### BRIEF DESCRIPTION OF THE DRAWINGS

In the accompanying drawings:

FIG. 1 is a schematic block diagram to show the configuration of a recording apparatus of an embodiment of the invention;

FIG. 2 is a drawing to show reception streams of a physical channel received at a tuner;

FIG. 3 is a drawing to show the configuration of a storage section of the recording apparatus of the embodiment of the invention;

FIG. 4 is a flowchart to show the recording operation of the recording apparatus of the embodiment of the invention;

FIG. 5 is a flowchart to show the playback operation of the recording apparatus of the embodiment of the invention;

FIG. 6 is a drawing to describe the playback operation of the recording apparatus of the embodiment of the invention;

FIG. 7 is a flowchart to show the playback operation of the recording apparatus of the embodiment of the invention;

FIG. 8 is a flowchart to show edit operation of the recording apparatus of the embodiment of the invention;

FIGS. 9A to 9D are drawings to show display screen examples of a display at the edit processing time of the recording apparatus of the embodiment of the invention;

FIG. 10 is a flowchart to show the recording operation of a recording apparatus of another embodiment of the invention;

FIG. 11 is a flowchart to show the recording operation of a recording apparatus of another embodiment of the invention; and

FIG. 12 is a drawing to describe the recording operation of the recording apparatus of the embodiment of the invention.

### DETAILED DESCRIPTION OF THE PREFERRED EMBODIMENTS

A recording apparatus of an embodiment of the invention will be discussed with reference to the accompanying drawings.

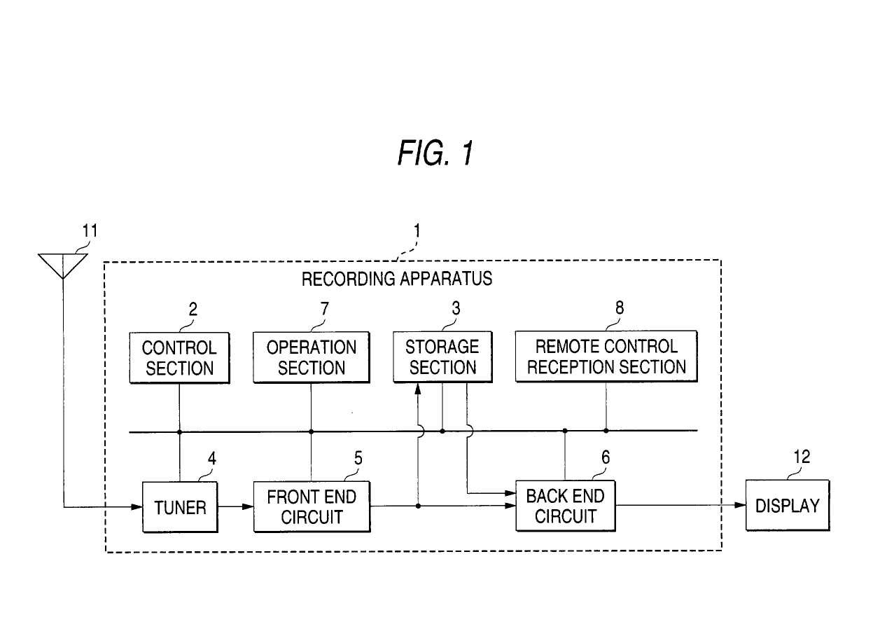

FIG. 1 is a schematic block diagram to show the configuration of a recording apparatus of an embodiment of the invention. The recording apparatus 1 of the embodiment comprises a control section 2, a storage section 3, a tuner 4, a front end circuit 5, a back end circuit 6, an operation section 7, and a remote control reception section 8. The control section 2 has a CPU for controlling the operation of the main unit, ROM storing an operation program, RAM for temporarily storing data occurring at the operation time, non-volatile memory, such as EEPROM, storing parameters used at the operation time, and the like. The storage section 3 stores program record data on a storage medium such as a hard disk or a DVD. The tuner 4 takes out a broadcast signal of the specified physical channel from a digital broadcast signal received at an antenna 11.

Digital broadcasts will be discussed briefly. In the digital broadcasts, a plurality of programs can be broadcasted on one physical channel. Specifically, a plurality of virtual channels can be formed on one physical channel and a program can be broadcasted for each virtual channel. In the digital broadcasts, the program to be viewed is specified as the virtual channel.

The broadcast signal of the digital broadcast contains not only data of the program broadcasted on the channel, but also data of EPG (Electric Program Guide), VCT (Virtual Channel Table), PMT (Program Map Table), etc. The EPG is a program guide indicating the programs scheduled to be broadcasted. The VCT is information indicating the configuration of virtual channels in the physical channel. It contains PID information of video and audio making up each program broadcasted for each virtual channel. The VCT may not exist in the broadcast signal of the physical channel wherein a plurality of virtual channels are not formed. However, the PMT contains the PID information of the video and audio making up each broadcasted program. The PID information corresponds to channel information mentioned in the invention. The PID information is distributed on all physical channels in the digital broadcasts.

The physical channel whose broadcast signal is taken out by the tuner 4 is the physical channel wherein the specified virtual channel is formed.

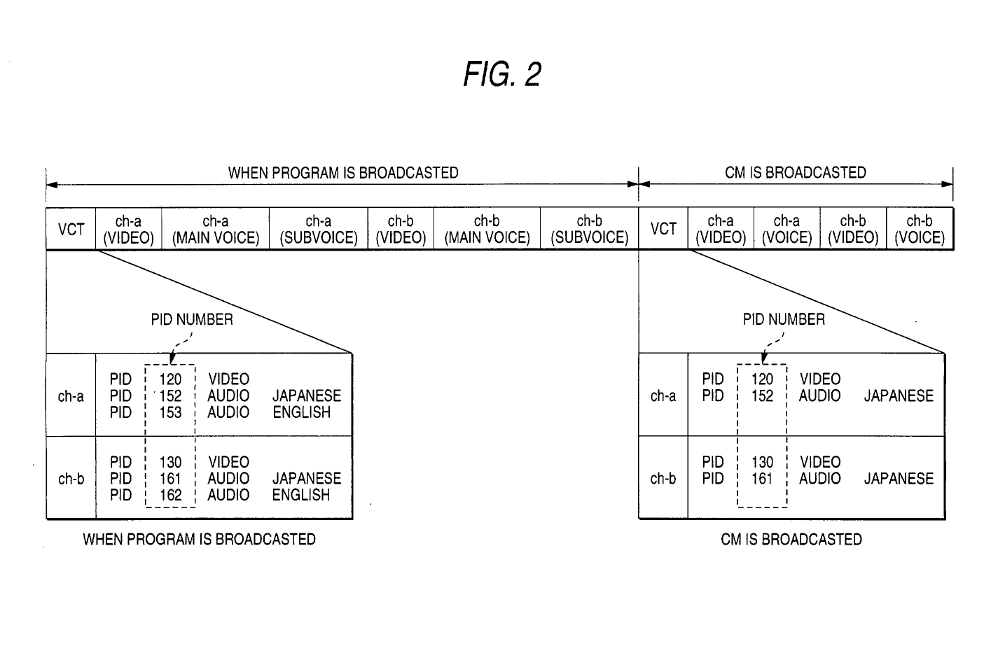

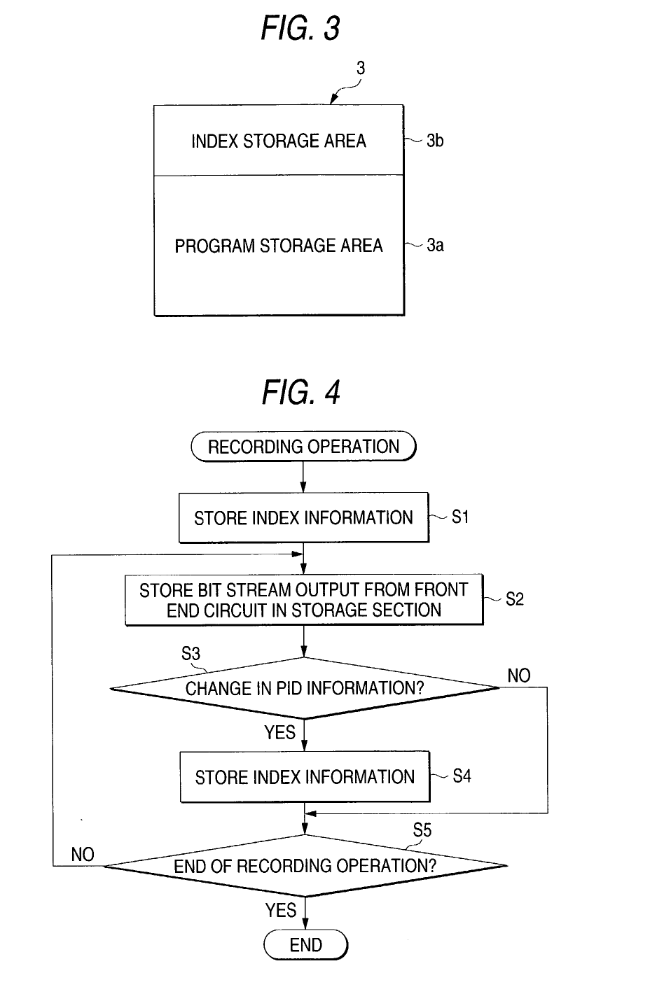

FIG. 2 is a drawing to show reception streams of the physical channel whose broadcast signal is taken out by the tuner 4. Here, the physical channel wherein two virtual channels (ch-a and ch-b) are formed is taken as an example. In FIG. 2, the left is a reception stream taken out when a program is broadcasted and the right is a reception stream taken out when a CM is broadcasted. The VCT contains the PID information indicating the PID number of video and audio making up each of programs (or CMs) broadcasted on ch-a and ch-b. The programs broadcasted on the two virtual channels ch-a and ch-b are bilingual broadcasts and CMs are monolingual broadcasts. Thus, as shown in the figure, the PID information contained in the VCT when a program is broadcasted differs from that when a CM is broadcasted. Specifically, there are two types of data forming audio when a program is broadcasted; there is one type when a CM is broadcasted.

The video data and audio data making up a program broadcasted for each virtual channel are each divided into a predetermined length for distribution. A header containing the PID number is added to each data. Therefore, the headers added to the video data and audio data contained in digital broadcast signals are analyzed, whereby which virtual channel the program data is broadcasted on, whether the data is video data or audio data, and further whether the data, if the data is audio data, is main-voice data or subvoice data can be determined. Each data is compressed by MPEG2, etc.

The reception stream taken out in the tuner 4 is input to the front end circuit 5. The front end circuit 5 takes out from the reception stream the VCT and the data of video and audio making up the program broadcasted on the specified virtual channel and inputs a bit stream consisting of the VCT and the data to the back end circuit 6. For example, if the virtual channel ch-a is specified, the bit stream consisting of the VCT and the data of video and audio making up the program broadcasted on ch-a is extracted and output. At this time, the front end circuit 5 discards the data of video and audio making up the program broadcasted on ch-b.

The back end circuit 6 decodes the input bit stream and converts and the result to video and audio signals in the NTSC system for output. A display 12 of a television receiver in the NTSC system, etc., is connected to the back end circuit 6. On the display 12, the user can view the program broadcasted on the specified virtual channel.

The bit stream output from the front end circuit 5 is stored in the storage section 3, whereby the program broadcasted on the specified virtual channel is recorded. The storage section 3 stores the bit stream output from the front end circuit 5 on a storage medium such as a hard disk or a DVD.

The storage section 3 has a program storage area 3a for storing the bit stream output from the front end circuit 5 and an index storage area 3b for storing index information indicating the title, storage location, etc., of each of the programs stored in the program storage area 3a.

Input keys to the main unit are placed on the operation section 7. The remote control reception section 8 receives control code transmitted by radio wave or infrared ray from a remote control unit (not shown).

The operation of the recording apparatus 1 of the embodiment is as follows:

FIG. 4 is a flowchart to show the recording operation of the recording apparatus of the embodiment. When a recording operation start command is given, the recording apparatus starts the recording operation shown in FIG. 4. The recording operation start command can be given as a predetermined key on the operation section 7 or the remote control unit is operated. The recording operation maybe started as the recording apparatus 1 is programmed to record a program as known.

When starting the recording operation, the recording apparatus 1 stores the storage start location of the program to be recorded (storage start location of bit stream in the program storage area 3a of the storage section 3), the current PID information, the current time, the program title, etc., in the index storage area 3b of the storage section 3 as index information (s1). Then, the bit stream output from the front end circuit 5 is stored in the program storage area 3a of the storage section 3 in order (s2). The recording apparatus 1 determines whether or not change is made in the PID information as for the recorded program (s3). If change is made in the PID information, the recording apparatus 1 stores index information indicating that change is made in the PID information in the index storage area 3b (s4) . At s4, the storage location of the bit stream in the program storage area 3a when change is made in the PID information, PID information after the change, the current time, and the like are stored as index information.

The recording apparatus 1 repeats steps s2 to s4 until the timing at which the recording operation is terminated (s5). The recording operation termination timing is when the user operates a key for giving a recording operation stop command on the operation section 7 or the remote control unit or when the recording end time in programmed recording is reached.

As the recording operation is performed as described above, as for the program (program and CM) recorded in the program storage area 3a of the storage section 3, the index information when the PID information changes is stored in the index storage area 3b. That is, the index information indicating the PID information change is added to the recorded program.

As described above, the index information changes in the program (program and CM) when change is made from the program to CM or from CM to the program. Therefore, the separation between the program and CM in the bit stream stored in the program storage area 3a as the recording operation is performed can be determined from the index information stored in the index storage area 3b.

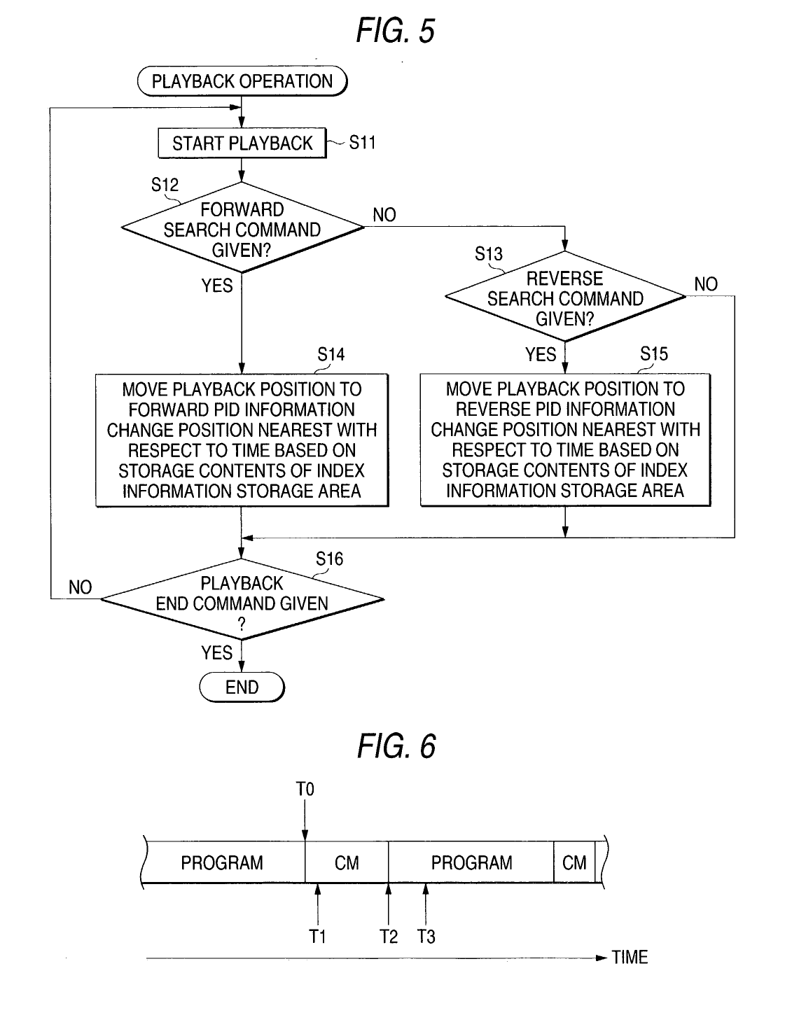

Next, the playback operation of the recording apparatus 1 of the embodiment will be discussed. FIG. 5 is a flowchart to show the playback operation of the recording apparatus of the embodiment. When a playback operation start command is given, the recording apparatus 1 starts the playback operation (s1). The playback operation start command is given as a predetermined key on the operation section 7 or the remote control unit is operated.

The recording apparatus 1 reads the index stored in the index storage area 3b as for the program instructed to be played back, acquires the storage start location in the program storage area 3a, reads the data stored in the program storage area 3a in order based on the acquired storage location, and inputs the data into the back end circuit 6. The bit stream read from the program storage area 3a of the storage section 3 is input to the back end circuit 6. The back end circuit 6 decodes the input bit stream, converts the result into video and audio signals in the NTSC system, and outputs the video and audio signals. The user can view the program stored in the storage section 3 on the display 12 connected to the back end circuit 6.

The recording apparatus 1 determines whether or not a forward or reverse search command is given at the playback operation time (s12, s13).

The forward search is processing of detecting the nearest record position of the bit stream with PID information change in the direction of advancing the time relative to the current playback position and skipping the playback position to the detected record position. In contrast, the reverse search is processing of detecting the nearest record position of the bit stream with PID information change in the direction of turning back the time relative to the current playback position and restoring the playback position to the detected record position.

The forward or reverse search command can be given as a key on the operation section 7 or the remote control unit is operated.

When determining that a forward search command is given, the recording apparatus 1 moves the playback position to the forward PID information change position nearest with respect to the time (direction of advancing the time) relative to the current playback position based on the index information of the program being played back, stored in the index storage area 3b (s14) . When determining that a reverse search command is given, the recording apparatus 1 moves the playback position to the reverse PID information change position nearest with respect to the time (direction of turning back the time) relative to the current playback position based on the index information of the program being played back, stored in the index storage area 3b (s15).

The forward search and the reverse search will be discussed more specifically with reference to FIG. 6. Assume that a program is played back in the direction of the time axis shown in FIG. 6. T0 is the change timing from the program to CM. When the user performs operation of giving a forward search command to skip the CM at T1, the recording apparatus 1 detects PID information change position T2 in the time advancing direction from the current playback position T1 and nearest with respect to the time, namely, the bit stream record position at which change is made from CM to program. The change position T2 is detected from the index information stored in the index storage area 3b. The recording apparatus 1 starts the playback operation at the change position T2. That is, the recording apparatus 1 skips the record part between T1 and T2 without playing it back.

Thus, when the played-back program is changed to a CM, the user can skip the CM simply by operating the key for giving a forward search command. Therefore, the operability of the user can be enhanced and the user can keep calm in viewing the program.

The user performing the operation of giving a forward search command may fail to see a part played back after the CM is skipped for some reason. For example, if the user fails to see the part between T2 and T3, he or she performs entry operation of giving a reverse search command. The recording apparatus 1 detects the PID information change position T2 in the time turning back direction from the current playback position T3 and nearest with respect to the time. The change position T2 is detected from the index information stored in the index storage area 3b as with the forward search. The recording apparatus 1 starts the playback operation at the change position T2.

Therefore, the user can easily return the part that the user fails to see during the playback and can view the part. Accordingly, the operability of the user can be more enhanced.

The recording apparatus 1 repeats s11 to s15 until it determines that a playback end command is given at s16.

Thus, when the playback position reaches a CM, the recording apparatus 1 of the embodiment enables the user to view the recorded program while skipping the CM simply by performing entry operation of giving a forward search command.

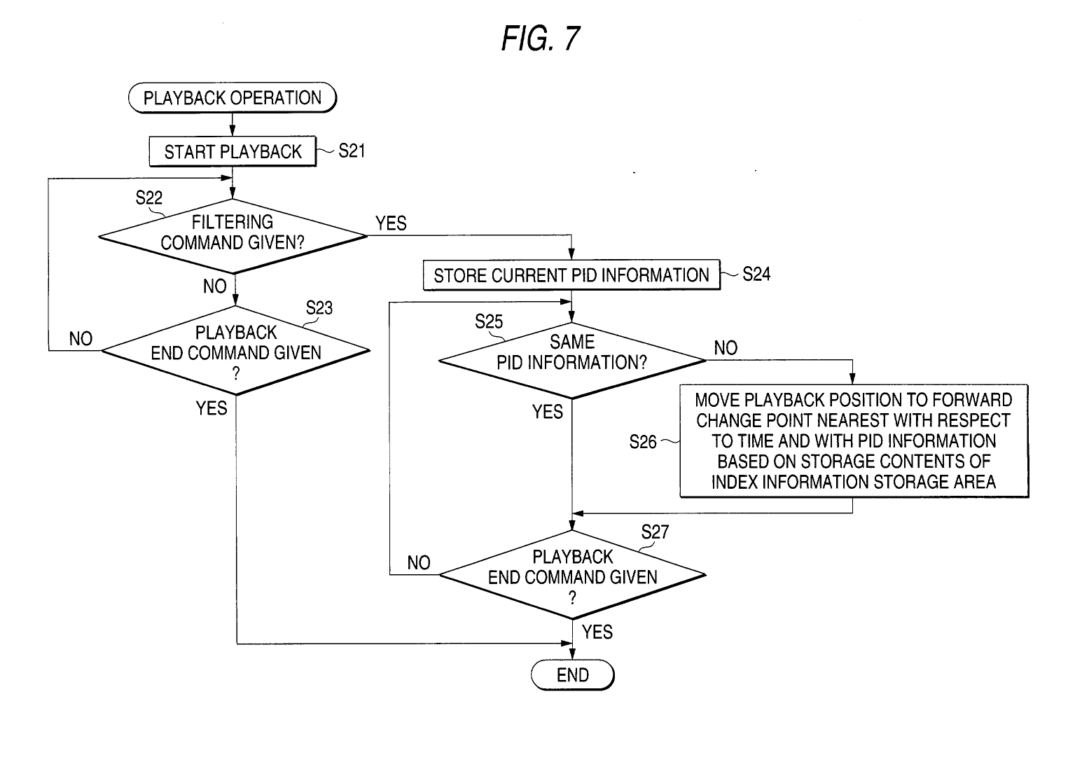

The playback operation may be replaced with operation shown in FIG. 7. The playback operation shown in FIG. 7 will be discussed. When a playback operation start command is given, the recording apparatus 1 starts the playback operation. When the recording apparatus 1 starts the playback operation at s21, it determines whether or not a filtering command or a playback operation end command is given (s22, s23). s21 is the same as s1.

If the recording apparatus 1 determines that a playback operation end command is given, it terminates the playback operation. If the recording apparatus 1 determines that a filtering command is given at s22, it stores the PID information of the bit stream played back at present (s24).

The filtering command can be given as a predetermined key on the operation section 7 or the remote control unit is operated. Usually, when a program is played back, the user performs the operation of giving the filtering command. In this case, the PID information of the program is stored at s24. The recording apparatus 1 determines whether or not the PID information of the bit stream played back is the same as the PID information stored at s24 (s25) and if the PID information is the same as the PID information stored at s24, the recording apparatus 1 determines whether or not a playback operation end command is given (s27) . While the playback position is the program, it is determined at s25 that the PID information is the same as the PID information stored at s24.

On the other hand, when the playback position becomes a CM, it is determined that the PID information is not the same as the PID information stored at s24. If the recording apparatus 1 determines at s25 that the PID information is not the same as the PID information stored at s24, the recording apparatus 1 detects the bit stream storage location forward with respect to the time relative to the current playback position and with the PID information being the same as the PID information stored at s24 from the index stored in the index storage area 3b, and moves the playback position to the detected position (s26). The playback position moved at s26 is the change position from CM to program. When the filtering command is given, then the recording apparatus 1 plays back only the program automatically while skipping CMs.

Thus, when the playback position changes from program to CM, the recording apparatus 1 executes s26 and moves the playback position to the change position from CM to program, so that only the program is played back and no CM is played back. Therefore, when viewing a program, the user performs the filtering operation only once when the program is played back, and later can view only the program with no CMs.

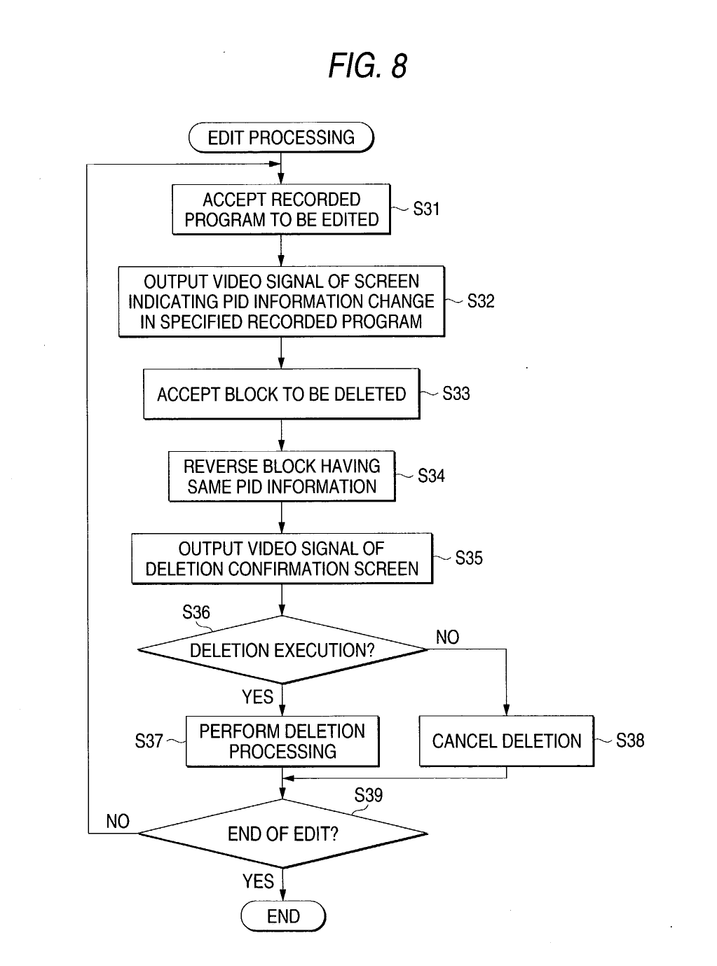

Further, the recording apparatus 1 of the embodiment further executes the following edit processing. The edit processing is processing of editing record data stored in the program storage area 3a of the storage section 3. FIG. 8 is a flowchart to show the edit processing.

The recording apparatus 1 accepts specification of the recorded program to be edited (s31). At s31, the recorded program can be specified as a key on the operation section 7 or the remote control unit is operated. For the program specified at s31, the recording apparatus 1 outputs from the back end circuit 6 a video signal for displaying a screen indicating PID information change in a series of record data stored in the program storage area 3a based on the index information stored in the index storage area 3b (s32).

The back end circuit 6 is provided with a known OSD (On Screen Display) function. The step s32 is executed using the OSD function.

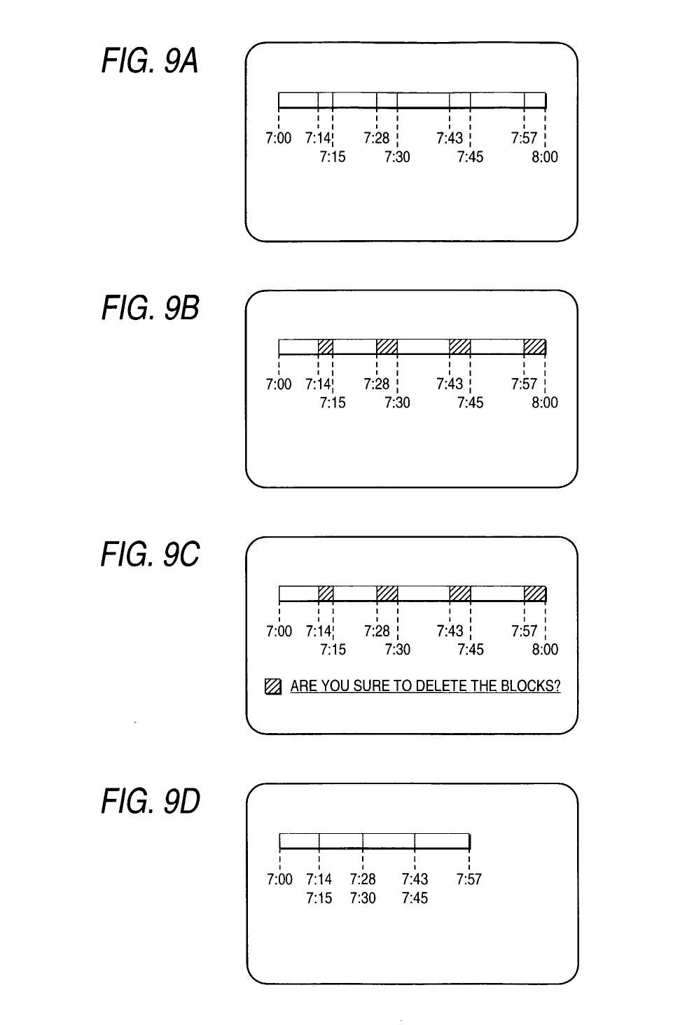

At s32, a video signal to display the screen shown in FIG. 9A, for example, is output. Specifically, the bit stream of the specified program is divided into blocks indicating PID information change and a video signal for displaying a screen indicating the record time of each block is output.

Next, the recording apparatus 1 accepts specification of the block to be deleted (s33) . The user can easily determine which block the program is and which block a CM is from the screen shown in FIG. 9A. The user specifies each CM block as the block to be deleted. The block can also be specified as a key on the operation section 7 or the remote control unit is operated.

When the block to be deleted is specified, the recording apparatus 1 also reverses display of other blocks having the same PID information as the specified block (s34) (see FIG. 9B). A video signal for displaying a deletion confirmation screen shown in FIG. 9C is output from the back end circuit 6 (s35), and a wait is made for entry of deletion execution or cancel (s36). When deletion execution is entered, the recording apparatus 1 performs deletion processing of making ineffective the bit stream stored in the storage location corresponding to the reverse-displayed block in the program storage area 3a and making contiguous the bit stream stored in the storage location corresponding to the remaining blocks (s37) . As the deletion processing is executed, the CM parts can be cut from the record data of the specified program to be edited (see FIG. 9D).

When deletion cancel is entered, the recording apparatus 1 cancels deletion of the specified block (s38).

The recording apparatus 1 repeats s31 to s38 until it determines that an edit processing end command is given at s39.

Thus, the recording apparatus 1 of the embodiment enables the user to easily edit so as to cut the CM parts from the record data. At the editing time, the bit stream of the program is divided into blocks indicating PID information change and a screen indicating the record time of each block is displayed, so that the user can easily determine which block the program is and which block a CM is. Accordingly, the user can specify the block to be deleted without being at a loss which to select.

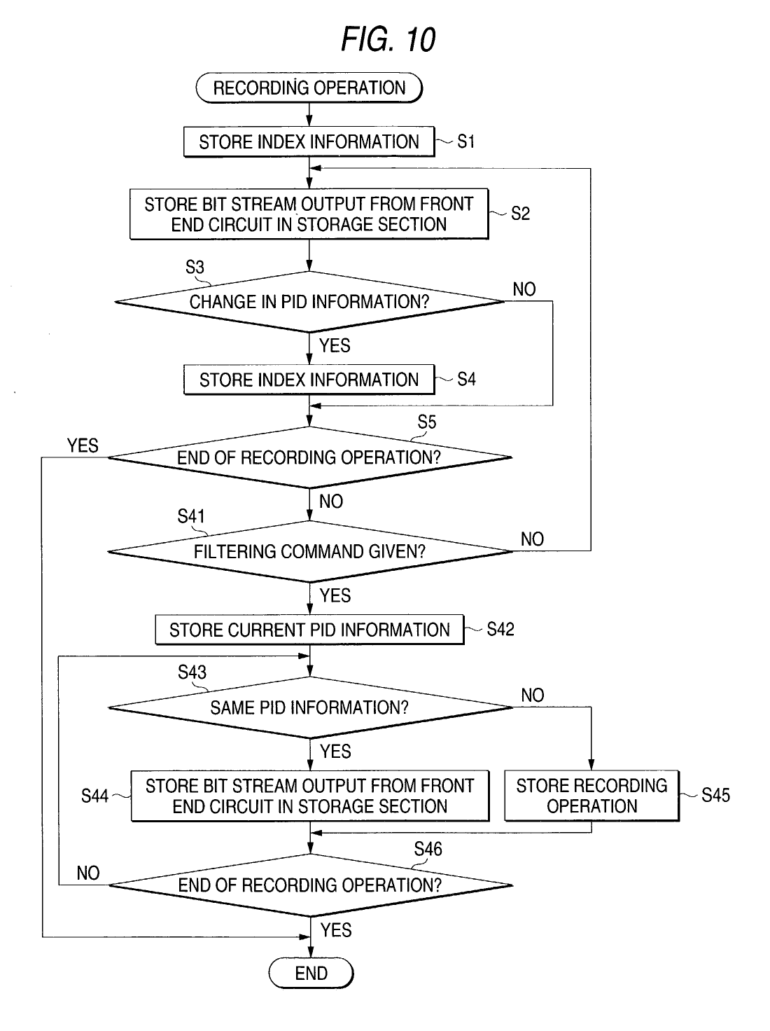

Next, another embodiment of the invention will be discussed. A recording apparatus 1 of the embodiment has the configuration previously described with reference to FIG. 1. The recording apparatus 1 of the embodiment differs from the recording apparatus of the embodiment described above in recording operation. FIG. 10 is a flowchart to show the recording operation of the recording apparatus of the embodiment.

The recording apparatus 1 of the embodiment determines whether or not a filtering command is given at s41 while executing the recording operation at s1 to s5 previously described with reference to FIG. 4. If the recording apparatus 1 determines that a filtering command is given, it stores the PID information of the bit stream stored in a program storage area 3a of a storage section 3 at present (s42). The filtering command can be given as a predetermined key on an operation section 7 or a remote control unit is operated. Usually, when a program is recorded, the user performs the operation of giving the filtering command. The recording apparatus 1 stores the PID information of the program at s42.

Then, the recording apparatus 1 stores the bit stream parts having the same PID information as the PID information stored at s42 in the program storage area 3a of the storage section 3 (s43, s44), and stops the recording operation for the bit stream parts not having the same PID information as the PID information stored at s42 (does not store the bit stream parts in the program storage area 3a of the storage section 3) (s43, s45).

Steps s43 to s45 are repeated until it is determined that a recording operation end command is given at s46.

Therefore, the bit stream parts having the same PID information as the PID information stored at s42 are stored in the program storage area 3a of the storage section 3 and the bit stream parts not having the same PID information are not stored. Thus, the user performs the operation for giving the filtering command only once when the program is being recorded, whereby the bit stream parts of CMs are not stored and only the bit stream parts of the program are stored.

That is, the program can be recorded with CM parts cut and thus only the program is played back at the playback time. Accordingly, the storage capacity of the storage section 3 can be used efficiently.

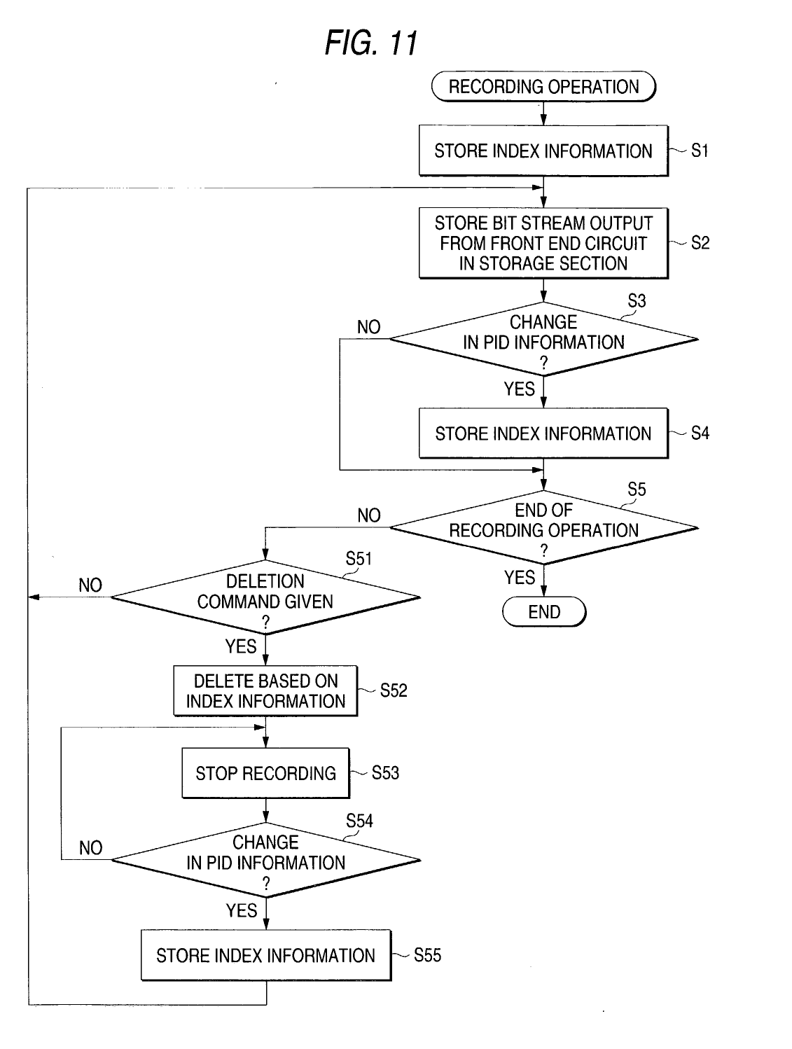

Still another embodiment of the invention will be discussed. A recording apparatus 1 of the embodiment has the configuration previously described with reference to FIG. 1. The recording apparatus 1 of the embodiment differs from the recording apparatus of the embodiment described above in recording operation. FIG. 11 is a flowchart to show the recording operation of the recording apparatus of the embodiment.

The recording apparatus 1 of the embodiment determines whether or not a deletion command is given at s51 while executing the recording operation at s1 to s5 previously described with reference to FIG. 4. The deletion command can be given as a key on an operation section 7 or a remote control unit is operated.

If the recording apparatus 1 determines that no deletion command is given, it returns to s2. On the other hand, if the recording apparatus 1 determines that a deletion command is given, it detects the storage location with PID information change of the current bit stream stored in a program storage area 3a of a storage section 3. The recording apparatus 1 deletes the bit stream stored from the detected storage location to the current storage location (s52) . The recording apparatus 1 stops the recording operation until the PID information of the bit stream output from a front end circuit 5 changes (s53, s54).

When the recording apparatus 1 detects change in the PID information at s54, it stores index information (s55), returns to s2, and restarts the recording operation.

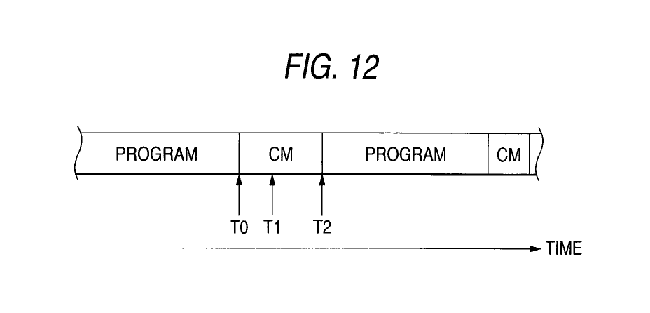

The processing at steps s51 to s54 will be discussed specifically with reference to FIG. 12. The recording apparatus 1 stores the bit stream output from the front end circuit 5 in the program storage area 3a of the storage section 3.

The user performs the key operation of giving a deletion command at timing T1 wherein the bit stream part of a CM rather than the program is stored in the program storage area 3a.

The recording apparatus 1 detects the bit stream storage location at timing T0 at which change is made from the program to the CM at s52. At s52, the bit stream part of the CM stored between T0 and T1 is deleted at s52.

At s52, in fact, the bit stream part stored between T0 and T1 is not deleted and the bit stream storage location is restored to the bit stream storage location at the timing T0 at which change is made from the program to the CM.

The recording apparatus 1 stops storing, namely, recording the bit stream in the program storage area 3a until change is made in the PID information. Change is made in the PID information at timing T2 at which change is made from the CM to the program. The recording apparatus 1 restarts the recording operation at the timing T2 at which change is made from the CM to the program. The bit stream output from the front end circuit 5 after the timing T2 is stored starting at the bit stream storage location at the timing T0 at which change is made from the program to the CM.

Therefore, as the user operates the key for giving a deletion command when a CM is recorded, the recording apparatus 1 of the embodiment can record the program with the CM cut. Accordingly, the storage capacity of the storage section 3 can be used efficiently.

As was described above, according to the invention, the user can easily skip a CM by performing easy operation when the recorded program is played back, and the operability of the user can be enhanced. The user can keep calm in viewing the played program.

Since the program recorded in the storage section can be edited, CMs can be cut for playing back only the program.

Further, the program can be recorded with CM parts cut, so that the storage capacity of the storage section can be used efficiently.

What is claimed is:

1. A recording apparatus comprising:
reception means for receiving a digital broadcast signal of a specified channel;
recording means for recording a program broadcasted on the specified channel;
channel information extraction means for extracting channel information of the program recorded by said recording means from the digital broadcast signal received by said reception means;
channel information change detection means for detecting change in the channel information extracted by said channel information extraction means;
index means, when said channel information change detection means detects change in the channel information, for adding an index indicating change in the channel information to the program recorded by said recording means;
playback means for playing back the program recorded by said recording means; and
edit means for editing the program based on the index added to the program recorded by said recording means,
wherein said playback means is means for storing the channel information of the played program when a predetermined entry is made when the program is played back, and skipping record data having channel information different from the stored channel information based on the index added by said index means, and
wherein said recording means is means for storing the channel information of the recorded program when a predetermined entry is made when the program is recorded, and temporarily stopping the recording operation in the time period during which channel information differs from the stored channel information.

2. A recording apparatus comprising:
reception means for receiving a digital broadcast signal of a specified channel;
recording means for recording a program broadcasted on the specified channel;
channel information extraction means for extracting channel information of the program recorded by said recording means from the digital broadcast signal received by said reception means;
channel information change detection means for detecting change in the channel information extracted by said channel information extraction means; and
index means, when said channel information change detection means detects change in the channel information, for adding an index indicating change in the channel information to the program recorded by the recording means.

3. The recording apparatus as claimed in claim 2 further comprising playback means for playing back the program recorded by the recording means, the playback means being means for storing the channel information of the played program when a predetermined entry is made when the program is played back, and skipping record data having channel information different from the stored channel information based on the index added by said index means.

4. The recording apparatus as claimed in claim 2 or 3 wherein said recording means is means for storing the channel information of the recorded program when a predetermined entry is made when the program is recorded, and temporarily stopping the recording operation in the time period during which channel information differs from the stored channel information.

5. The recording apparatus as claimed in claim 2 or 3 wherein said recording means is means for temporarily stopping the recording operation until change is made in the channel information of the recorded program when a predetermined entry is made at the program recording time.

6. The recording apparatus as claimed in claim 5 wherein the recording means has means for deleting the already recorded portion of the program having the same channel information as the recorded program when the predetermined entry is made.

7. The recording apparatus as claimed in claim 2 or 3 further comprising edit means for editing the program based on the index added to the program recorded by the recording means.
